(19) United States
(12) Patent Application Publication
(10) Pub. No.: US 2009/0159259 A1
(43) Pub. Date: Jun. 25, 2009

(54) Modular heat pump liquid heater system

(76) Inventor: Sunil Kumar Sinha, Katy, TX (US)

Correspondence Address: TROP, PRUNER & HU, P.C., 1616 S. VOSS ROAD, SUITE 750, HOUSTON, TX, 77057-2631, US

(21) Appl. No.: 12/316,822

(22) Filed: Dec. 17, 2008

Related U.S. Application Data
(63) Continuation-in-part of application No. 11/477,902, filed on Jun. 30, 2006.

(51) Int. Cl. G05D 23/00; F28D 15/00; F28F 27/00

(52) U.S. Cl. 165/287; 165/104.19; 165/301

(57) ABSTRACT

A heat pump liquid heater system comprises a liquid conduit to direct a flow of a liquid between a liquid inlet and a liquid outlet, and a plurality of heat pump liquid heaters. Each heat pump liquid heater comprises a heat transfer element to transfer heat to the liquid and a temperature sensor to detect temperature of the heated liquid. A controller controls operation of the heat pumps based on the detected temperature of the heated liquid. The liquid conduit through which the liquid flows includes a plurality of adaptor assemblies, each of which has a heat pump port adapted to receive a heat transfer element and a temperature sensor for extension into the liquid conduit.

This application is a continuation-in-part of U.S. patent application Ser. No. 11/477,902, entitled “Heat Pump Liquid Heater,” which was filed on Jun. 30, 2006.

### BACKGROUND

A Heat Pump Liquid Heater (“HPLH”) uses a refrigeration system to extract heat from the surrounding environment to heat a liquid. An HPLH system is based on a reverse refrigeration cycle with the HPLH system using a compressor to compress the refrigerant to a liquid state which is at a high pressure and temperature. After transferring heat to a liquid, the high temperature and pressure refrigerant is expanded to reduce its temperature and pressure. The expanded refrigerant then passes through an evaporator where it absorbs heat from the ambient air and is converted to a gaseous state. The gaseous refrigerant then is re-compressed in the compressor and the process repeats. In this manner, a liquid may be heated by both the heat from the ambient air and the power used to operate the compressor. Thus, an HPLH may be more than 100% efficient, making it attractive for use in an energy-conscious environment.

An HPLH system may be used to heat water for both domestic and commercial uses. Conventionally, both commercial and domestic water heating systems heat water that is stored in a reservoir for later use. Because the water is maintained at a desired temperature until used, inefficiencies are introduced in the system due to the need to continually heat the water to compensate for loss due to radiation. This problem has been addressed, in part, by the introduction of tankless water heating systems that do not hold water in a reservoir but instead heat the water on demand. However, in applications in which the demand for heated water varies widely throughout the day, providing water on demand at a desired temperature and in an efficient manner can be challenging. To address some of these problems, modular tankless water heating systems are known in which control circuitry is implemented in an attempt to more closely regulate water temperature. However, such systems rely on conventional electrical heating elements and thus do not offer the advantages that may be realized with a HPLH system.

### BRIEF DESCRIPTION OF THE DRAWINGS

FIG. 1 is a block diagram of a modular heat pump liquid heater system in accordance with an embodiment of the invention.

FIG. 2 illustrates an exemplary heat pump used in the system shown in FIG. 1, in accordance with an embodiment of the invention.

FIG. 3 is a partial cutaway view of an exemplary adaptor assembly in accordance with an embodiment of the invention.

FIG. 4 is a block diagram of an exemplary control scheme for controlling operation of a modular heat pump liquid heater system in accordance with an embodiment of the invention.

FIG. 5 is a block diagram of another exemplary modular heat pump liquid heater system in accordance with an embodiment of the invention.

FIG. 6 is a partial cross-sectional view of another exemplary adaptor assembly in accordance with an embodiment of the invention.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

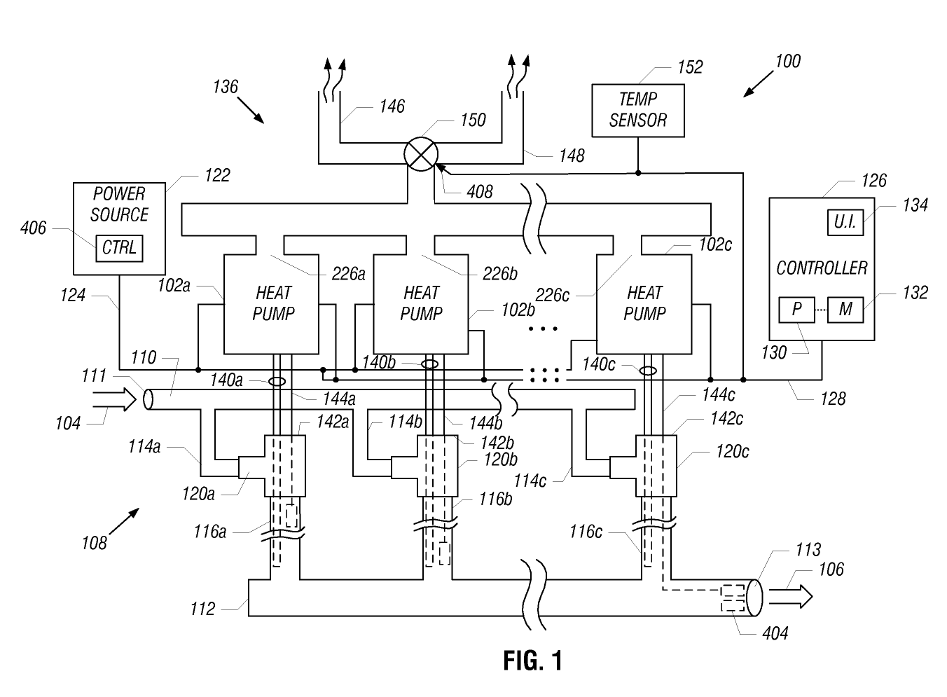

FIG. 1 is a block diagram of an exemplary embodiment of a modular heat pump liquid heater (HPLH) system 100. HPLH system 100 includes a plurality of heat pumps 102a-c arranged to heat an incoming liquid flow 104 to produce a heated outgoing liquid flow 106. The embodiment illustrated in FIG. 1 is a tankless liquid heating system in that it does not include a reservoir for holding heated liquid until ready for use. Instead, the incoming liquid flow 104 is heated as it flows through a liquid path 108 which generally includes an inflow path 110, an outflow path 112, and liquid conduits 114a-c and 116a-c. More particularly, the liquid flow 104 flows into an inlet 111 and through inflow path 110 to liquid conduits 114a-c. Liquid conduits 114a-c are coupled to liquid conduits 116a-c through adaptor assemblies 120a-c. Thus, liquid flows through conduits 114 and 116, which in turn is coupled to the outflow path 112. The heated liquid flow 106 exits the liquid path 108 through an outlet 113.

The adaptor assemblies 120a-c are coupled to heat pumps 102a-c in such a manner such that heat is transferred to the incoming liquid flow 104 while it is flowing through conduits 116a-c. More particularly, as shown in FIG. 1, each heat pump 102a-c includes a heating element 140a-c that is received in a port 142a-c of adaptor assemblies 120a-c. As will be explained in further detail below, the heating elements 140a-c extend into the conduits 116a-c where they transfer heat as the liquid is flowing therethrough. In the embodiment shown in FIG. 1, the heat pumps 102a-c also include temperature sensors 144a-c, respectively, which are received in ports 142a-c of adaptors 120a-c and extend into the conduits 116a-c.

In the system 100 shown in FIG. 1, power is supplied to the heat pumps 102a-c by a power supply system 122 and power bus 124. Power supply system 122 may include any of a variety of energy sources for providing power to system 100, including a public electricity grid, electrical generators, fuel cells, solar power sources, etc.

The system 100 also includes a controller 126 to control operation of the system 100 via receipt of sensing signals from various monitoring circuits and transmission of command signals to various control circuits on an interconnect 128. The controller 126 includes a processor 130 to execute a program or other software code that is stored in a memory 132. Various parameters for the program stored in memory 132 may be input by a user through a user interface 134. Interface 134 may also provide visual or audible indications to the user to assist in inputting parameters and/or to provide status information regarding the operation of system 100.

In use, each of the heat pumps 102a-c may be installed in a rack. The rack facilitates installation of additional heat pumps 102 to meet increased demand or replacement of pumps 102 in the event a failure occurs or an upgrade is desired. The controller 126 also may be installed in the rack such that the user interface 134 is readily accessible and visible to a system operator. The various liquid conduits 114a-c and 116a-c may extend from the rack and be routed as appropriate through the facility in which the system 100 is employed.

In some embodiments of the invention, and as illustrated in FIG. 1, system 100 may include a duct system 136 to direct cool and/or dehumidified air vented from heat pumps 102a-c to a desired location. For instance, the cool air may be vented via a duct path 146 to an outside environment or may be used to cool and/or dehumidify an enclosed area via a duct path 148, such as a room within the structure in which the system 100 is employed. In the embodiment shown in FIG. 1, the duct system 136 includes a controllable vent valve 150 controlled by the controller 126 in response to temperature indications from an ambient temperature sensor 152 such that cool air is selectively vented to the outside environment (e.g., during a cool season) or to an enclosed area where cooling or dehumidification is desired (e.g., during a hot season).

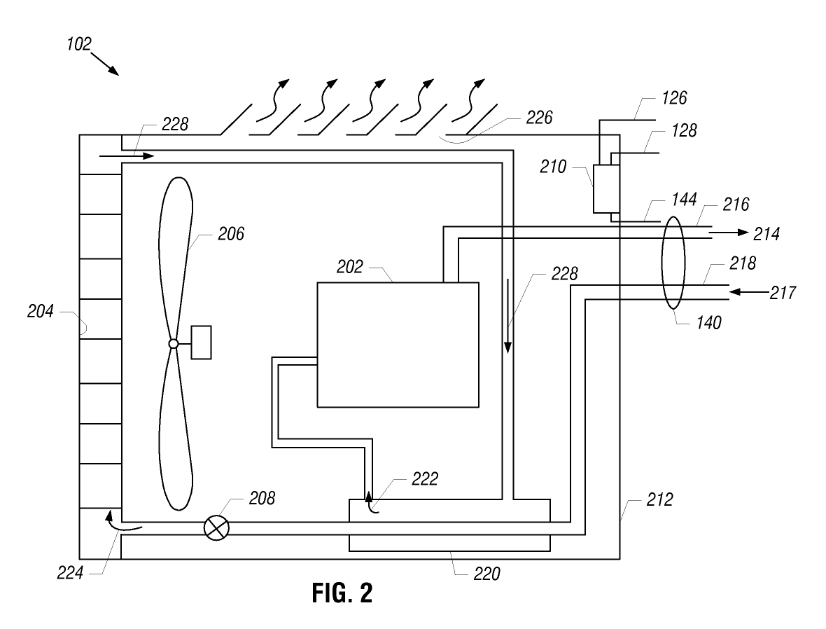

FIG. 2 is a diagram of an exemplary embodiment of a heat pump 102. The heat pump 102 includes a compressor 202, an evaporator 204 with a fan 206, an expansion device 208, and a control circuit 210 disposed within an enclosure 212. During operation of the heat pump 102 a compressed refrigerant 214 exits the compressor 202 at a temperature controlled via the control circuit 210 and the controller 126 in accordance with a desired control scheme. The compressed refrigerant 214 exits the compressor 202 at a high pressure and a high temperature and then flows into an outgoing leg 216 of the heat transfer element 140, such as a condenser tube. When the heat transfer element 140 is positioned in the liquid path 108, the heat transfer element 140 transfers heat from the heated refrigerant 214 to the relatively cooler liquid in the path 108. For instance, in the embodiment illustrated in FIG. 1, the heat transfer element 140 extends into the liquid conduit 116 and heat is transferred from the heated refrigerant 214 to the liquid entering the conduit 116 from the inflow path 110. As a result of the heat transfer, the refrigerant 214 is cooled and a resulting cooled refrigerant 217 then flows back to the heat pump 102 through the return leg 218 of the heat transfer element 140.

Although heat transfer has occurred, the cooled refrigerant 217 in the return leg 218 still has a higher temperature than the heated liquid in the liquid path 108. Thus, to enhance the efficiency of the heat pump 102, a portion of this heat may be recovered before the returning refrigerant 217 passes through an expansion process. For instance, as shown in FIG. 2, the returning refrigerant 217 passes through a heat exchanger 220 (e.g., a tube-in-tube heat exchanger) where a portion of the heat of the returning refrigerant 217 is transferred to a refrigerant 228 before the returning refrigerant 217 is expanded in the expansion device 208 (e.g., a capillary tube, an automatic expansion valve, a thermostatic expansion valve, electronic expansion valve, etc).

After the returning refrigerant 217 is expanded, a refrigerant 224 exits the expansion device 208 at a reduced pressure and then flows into the evaporator 204. In the evaporator 204, the refrigerant 224 is heated through absorption of heat from the ambient air. The heat exchange process in the evaporator 204 is aided by the fan 206 which moves the ambient air across the evaporator 204. The heat from the ambient air is transferred to the refrigerant 224 in the evaporator 204 and the cooled air is then vented from the heat pump enclosure 212 through a vent 226. Within the enclosure 212, a heated refrigerant 228 exits the evaporator 204 and then flows into the heat exchanger 220 where it is superheated by the returning refrigerant 217. Finally, the superheated refrigerant 222 enters the compressor 202, thus completing the cycle.

The cooled air from the vaporization process that exits the heat pump enclosure 212 through the vent 226 may simply be vented to the environment surrounding the heat pump system 100. In other embodiments, such as the embodiment shown in FIG. 1, the vent 226 of each of the heat pumps 102 may be connected to the duct system 136. In such an embodiment, the controller 126 may control the duct system 136 via a control valve 150 such that the cooled air is selectively directed to an exterior location via duct 146 or to another location (e.g., one or more rooms in a building in which the system 100 is installed) via duct 148 where it may be used for cooling, air conditioning and/or dehumidification purposes.

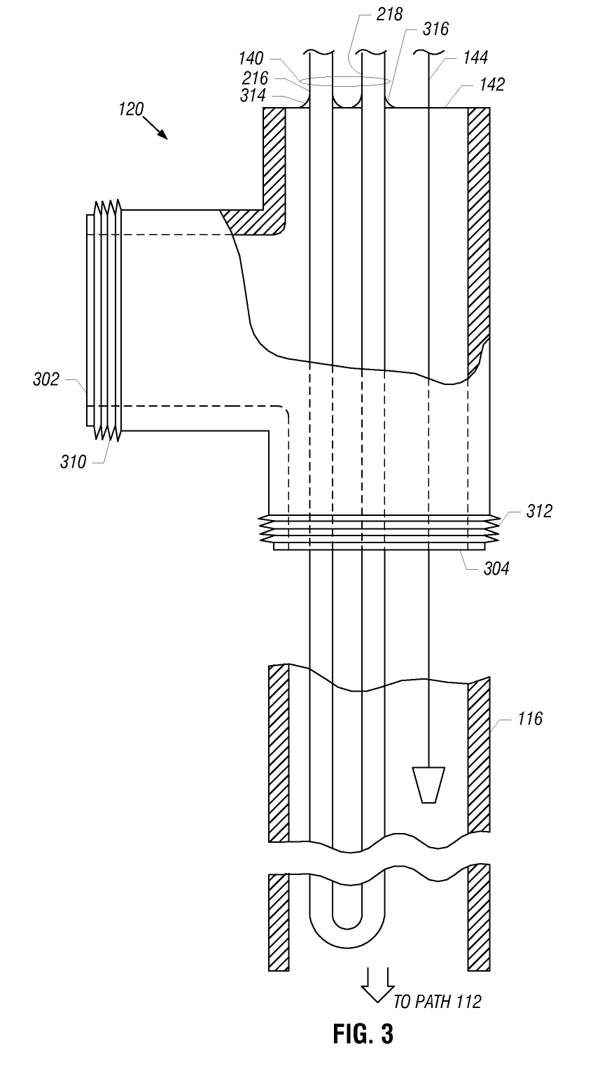

Turning now to FIG. 3, a close-up partially cutaway view of an exemplary adaptor assembly 120 in accordance with an embodiment of the invention is shown. The adaptor assembly 120 couples the heat pump 102 to the liquid path 108. Towards that end, when used in the embodiment illustrated in FIG. 1, adaptor assembly 120 includes an inlet port 302 through which a cool liquid flow is received from inflow path 110 through conduit 114. The inlet port 302 is coupled to an outlet port 304 via a passageway 306. As shown in FIG. 3, the heat pump port 142 also is in communication with the passageway 306 and is configured to receive the heat transfer element 140 and the temperature sensor 144.

In one embodiment, the inlet port 302 and outlet port 304 include threaded nipples 310 and 312 to which the liquid conduits 114 and 116 may be attached via appropriate threaded fittings. In other embodiments, the conduits 114 and 116 may be coupled to the ports 302 and 304 through compression-type fittings or any other suitable fitting. The heat pump port 308 includes two apertures through which the outgoing leg 216 and the return leg 218 of the condenser tube 140 are passed. Welds 314 and 316 may be formed about the legs 216 and 218 proximate the apertures to prevent liquid from leaking from the system 100. The heat pump port 142 also includes an aperture through which the temperature sensor 144 may be inserted. In other embodiments, the heat pump port 142 may be configured to receive additional sensors for monitoring a desired parameter in the liquid flow path 108, such as additional temperature sensors, flow rate sensors, etc.

As shown in FIG. 3, the legs 216 and 218 of the condenser tube 140 and the temperature sensor 144 pass through the heat pump port 142, into passageway 306, and out of the adaptor assembly 120 through the outlet port 304. In the embodiment shown, from the outlet port 304, the condenser tube 140 extends along the length of the liquid conduit 116 so that heat may be transferred to the liquid flowing in the conduit 116. In one embodiment, the condenser tube 140 and temperature sensor 144 extends along the entire length of the liquid conduit 116 to the outflow path 112. In other embodiments, the condenser tube 140 and/or the temperature sensor 144 may extend only partially along the length of the conduit 116. In yet other embodiments, the condenser tube 140 may extend along substantially the entire length or partially along the length of the conduit 166, while the temperature sensor 144 may be positioned in the conduit 116 proximate the outlet port 304 of the adaptor assembly 120. In yet still other embodiments of the invention, the temperature sensor 144 associated with at least one of the heat pumps 102a-c (such as sensor 144c as shown in FIG. 1) may extend past the end of conduit 116 such that it is positioned proximate the outlet 113 of the outflow path 112. In yet other embodiments, a separate temperature sensor may be provided at the outlet 113 of the outflow path 112. For instance, one of the adaptor assemblies may be configured to receive two temperature sensors, one of which is positioned in the liquid conduit 116 and the other of which is positioned proximate the outlet 113 of the outflow path 112. Alternatively, the temperature sensor at the outlet 113 is not associated with any of the heat pumps 102a-c, but is a separate sensor coupled to the controller 126.

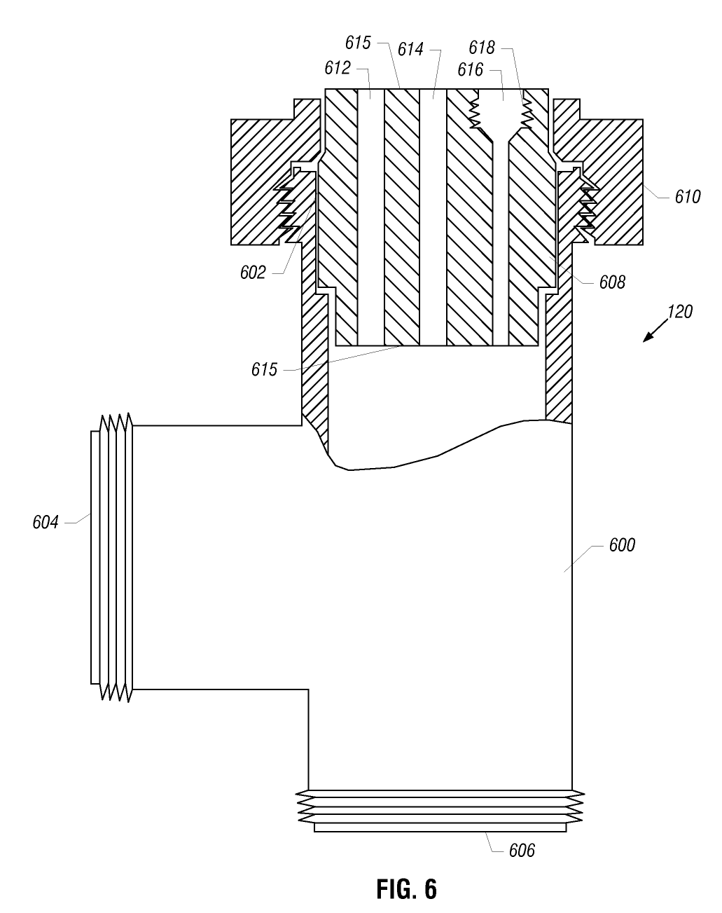

In some embodiments, and as shown in FIG. 6, the adaptor assembly 120 may be made of a t-shaped pipe fitting 600 having threaded open ends 602, 604 and 606. The heat pump port 142 (which is at the end 602) includes a removable feedthrough 608 which is received in the end 602 and secured thereto by a threaded union 610. The feedthrough 608 includes conduits 612 and 614 through which the legs 216 and 218 of the condenser tube 140 may be routed. Welds 314 and 316 may be formed about the legs 216 and 218 at either surface 613 or 615 of the feedthrough 308 so that the pump port 142 is substantially sealed against liquid leakage. By attaching the legs 216 and 218 to the removable feedthrough 608, the assembly of the HPLH system 100 is facilitated since only the removable feedthrough 608 is permanently attached to the condenser tube 140.

The feedthrough 608 also includes a third conduit 616 through which the temperature sensor 144 may be routed. In the embodiment shown, the conduit 616 includes a threaded portion 618 for removably coupling the sensor 144 to the adaptor assembly 120. The removable coupling allows the temperature sensor 144 to be easily removed and replaced in the event of a failure. It should be understood, however, that the configuration of the adaptor assembly 120 shown in FIG. 6 is only one exemplary embodiment and that other embodiments are contemplated and within the scope of the invention.

The condenser tube 140 may be made of any thermally conductive material, such as copper or a copper alloy. The tube 140 may be configured as a single wall tube or a double wall tube to prevent any contamination of the liquid in conduit 116 with refrigerant due to a rupture in an inner wall of the tube. In the double wall configuration, the condenser tube 140 may be made of concentric metal tubes having a uniform gap therebetween. However, due to the air gap, such a configuration may not be particularly efficient at transferring heat from the refrigerant flowing in the inner tube to the liquid in the liquid path. Accordingly, in other embodiments, to facilitate the transfer of heat between the tubes, the concentric tubes may be flattened into an oval configuration such that the air gap is nonuniform and either minimized or substantially eliminated along at least a portion of the circumference of the tubes.

In one embodiment of the invention, liquid conduits 114a-c may be made of a rigid material. However, in other embodiments, the conduits 114a-c are made of a flexible material to facilitate installation of the system 100 and routing of the liquid flow. In any embodiment, the conduits 114a-c may be coupled to the inflow path 110, as well as to the adaptor assemblies 120a-c, using appropriate fittings, such as threaded fittings, compression fittings, etc. Because the liquid flowing in conduits 116a-c is at a high temperature, conduits 116a-c are made of a high temperature material, and preferably a high temperature flexible material, such as crosslinked polyethylene (i.e., PEX) tubing to facilitate routing of the heated liquid flow. The conduits 116a-c may be coupled to the outflow path 112, as well as to the adaptor assemblies 120a-c, using appropriate fittings, such as threaded fittings, compression fittings, etc.

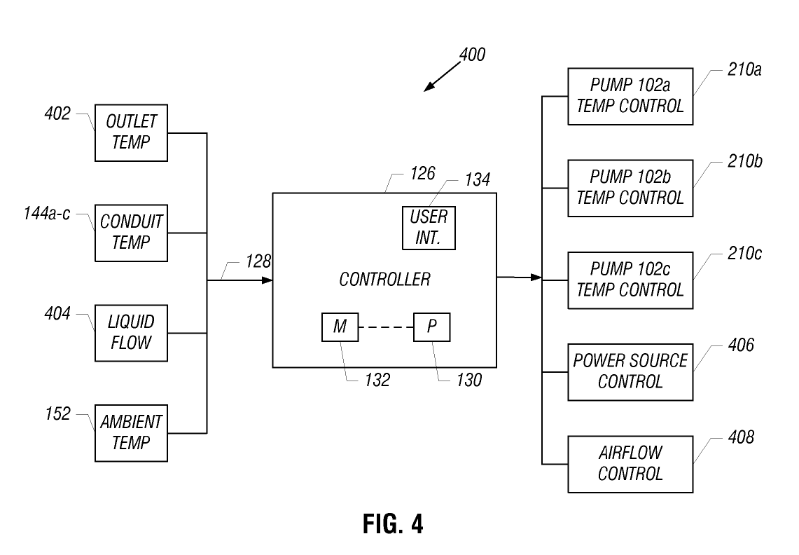

Turning now to FIG. 4, a block diagram representing an exemplary control scheme 400 for controlling operation of the system 100 is shown. In this control scheme 400, the controller 126 receives various inputs via the interconnect 128 from which it can generate command and control signals to control the system 100. For instance, the system 100 may include various monitoring circuits to which the controller 126 is coupled via the interconnect 128, such as temperature sensors 144a-c and/or 402 that provides indications of the temperature in each of the conduits 116a-c and/or an indication of the temperature at the outlet 113 of the outflow path 112, a flow monitor sensor 404 that monitors the flow rate of the liquid in the liquid path 108, and an ambient temperature circuit 152 that provides an indication of the ambient temperature in a location exterior to the system 100. The controller 126 may also receive various user inputs that are input by a system operator via the user interface 134. These inputs may include, for example, a liquid heating schedule that indicates periods of peak and off-peak demand, desired liquid temperature(s), type of liquid being heated, etc. These various inputs may be used by a control program stored in the memory 132 of the controller 126 and processed by the processor 130 to generate various control signals, status signals, etc. For instance, the control signals may include signals transmitted via the interconnect 128, such as temperature control signals to control circuitry 210a-c to regulate the temperature of each heat pump 102, power control signals to power supply control circuitry 406 and/or control circuitry 210a-c to remove or apply power to each heat pump 102, air duct control signals to air flow control circuitry 408 to direct the flow of cool air from the heat pumps 102 via the controllable vent valve 150, etc. Status signals may be provided to the user interface 134 to indicate to the operator information regarding the operation and status of the system 100, to assist in inputting control parameters, etc.

In accordance with this control scheme, the controller 126 may control the operation of system 100 to achieve optimum efficiency. For instance, in some embodiments, the heat pumps 102a-c may be identical and controlled in an identical manner. However, such a control scheme may not be optimal in terms of efficiency. Thus, in other embodiments, the operation of the heat pumps 102a-c may be controlled on an individual basis such that, for instance, only a certain number of heat pumps may be operational during periods of low or normal demand. In addition, one or more heat pumps 102 may be operated as low heat capacity pumps which are operational during periods of low demand while one or more other heat pumps 102 may be operated as high heat capacity pumps which are used only during periods of high demand. For instance, demand may be determined based on a demand schedule input by a user via user interface 134 or on a sensor signal from flow rate sensor 404 representative of the flow rate of the liquid in the liquid path 108. Yet further, certain heat pumps may be reserved as backup pumps where the backup pumps are used only in the event of a failure of other pumps.

Although three heat pumps 102 are shown in FIG. 1, it should be understood that the modular HPLH system 100 may include fewer or more heat pumps 102 as may be appropriate for the particular application in which the system 100 is employed. The adaptor assemblies 120 facilitate the addition or removal of the heat pumps 102 in the system 100. Further, to enhance adjustability of the control scheme and efficiency of the system 100, one or more heat pumps 102 may have a different heating capacity such that particular heat pumps 102 may be energized at different times depending upon the operating conditions and operating environment. Yet further, the tankless system of FIG. 1 may include an auxiliary reservoir to provide additional heated water in times of high demand. The liquid in the reservoir may be heated via a conventional electrical or gas heater or may be heated with one or more heat pump units in the manner described herein. In yet other embodiments, the tankless system 100 may include an auxiliary electrical or gas powered heater that may be used to provide additional heating to the heated liquid flowing in the outflow path 112 during periods of high demand.

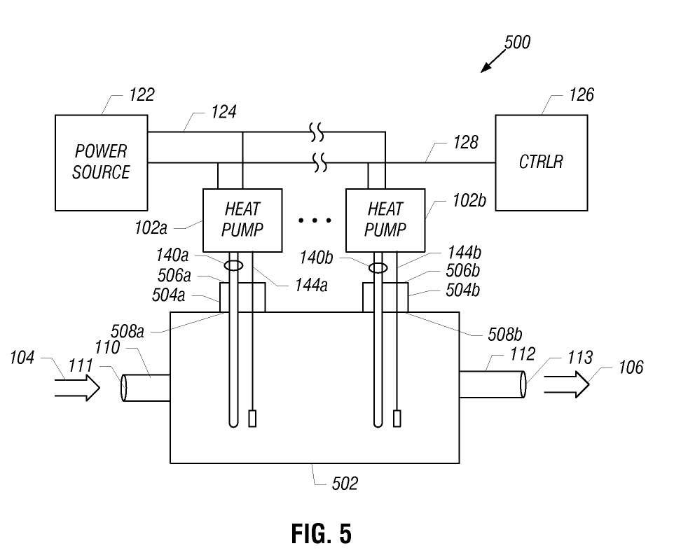

In other embodiments of the invention, the control scheme described above may be used in conjunction with a modular HPLH system that employs a reservoir to heat the liquid, such as the system 500 shown in FIG. 5. In FIG. 5, the liquid flow path 108 is a conduit comprising inlet 111, inflow path 110, liquid reservoir 502, outflow path 112, and outlet 113. Heat pumps 102a and 102b are coupled to the reservoir 502 via adaptor assemblies 504a and 504b, respectively. Adaptor assemblies 504a and 504b include heat pump ports 506a and 506b, respectively and outlet ports 508a and 508b, respectively. The heat pump ports 506a-b are configured to receive heat transfer elements 140a-b and temperature sensors 144a-b which extend through the assemblies 504a-b and into the reservoir 502 where they transfer heat to the liquid retained therein in the manner described above. Controller 126 again may be used to individually control operation of the heat pumps 102a and 102b in accordance with a control program stored in memory. Again, although only two heat pump 102a and 102b are shown in FIG. 5, it should be understood that any number of heat pumps 102 may be installed as may be appropriate for the particular application in which the system 500 is employed. Yet further, as discussed above with respect to the tankless system, the various heat pumps 102 may not be identical and may have different heating capacities.

Although the foregoing description has been made with reference to a water heating system, it should be understood that the system 100 and control scheme 400 may be used to heat any type of liquid, such as liquid chemicals.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A heat pump liquid heater system, comprising:
a liquid conduit to direct a flow of a liquid between a liquid inlet and a liquid outlet;
a plurality of heat pump liquid heaters, each heat pump liquid heater comprising a heat transfer element to transfer heat to the liquid and a temperature sensor to detect temperature of the liquid; and
a controller coupled to the plurality of heat pump liquid heaters, the controller configured to control operation of the heat pump liquid heaters based, at least in part, on the detected temperature of the liquid,
wherein the liquid conduit comprises a plurality of adaptor assemblies, each adaptor assembly comprising a heat pump port adapted to receive a heat transfer element for extension into the liquid conduit and a temperature sensor for detecting temperature of the liquid in the liquid conduit.

2. The heat pump liquid heater system as recited in claim 1, wherein the liquid conduit comprises a liquid reservoir, and wherein the heat transfer elements extend into the liquid reservoir to transfer heat to the liquid.

3. The heat pump liquid heater system as recited in claim 1, wherein the liquid conduit comprises a plurality of individual liquid conduits, and wherein each of the adaptor assemblies is coupled to one of the individual liquid conduits such that the corresponding heat transfer element extends into the individual liquid conduit.

4. The heat pump liquid heater system as recited in claim 3, wherein each adaptor assembly further comprises an inlet port, an outlet port, and a passageway coupling the inlet port, the outlet port and the heat pump port, wherein the outlet port is coupled to one of the individual liquid conduits.

5. The heat pump liquid heater system as recited in claim 3, wherein the individual liquid conduits are made of a flexible material.

6. The heat pump liquid heater system as recited in claim 1, wherein the controller further controls operation of the heat pump liquid heaters based on a liquid demand.

7. The heat pump liquid heater system as recited in claim 6, wherein the controller determines the liquid demand based on a demand schedule.

8. The heat pump liquid heater system as recited in claim 1, further comprising an air duct system to direct an air flow vented from the heat pump liquid heaters to a desired location.

9. The heat pump liquid heater system as recited in claim 8, wherein the controller is communicatively coupled to the duct system to selectively direct the air flow to the desired location.

10. The heat pump liquid heater system as recited in claim 9, wherein the controller selectively directs the air flow based on an indication of temperature at the desired location.

11. A heat pump liquid heater system, comprising:
a liquid inflow path;
a liquid outflow path;
a plurality of liquid conduits arranged in parallel to direct flow of a liquid from the inflow path to the outflow path;
a plurality of heat pump liquid heaters, each heat pump liquid heater comprising a heat transfer element to transfer heat to the liquid and a temperature sensor to detect a temperature of the liquid; and
a plurality of adaptor assemblies to couple the heat pump liquid heaters to the liquid conduits, each adaptor assembly configured to receive the heat transfer element of one of the heat pump liquid heaters for insertion into a corresponding liquid conduit.

12. The heat pump liquid heater system as recited in claim 11, further comprising a controller configured to control operation of the heat pump liquid heaters based, at least in part, on the detected temperature of the liquid.

13. The heat pump liquid heater system as recited in claim 12, wherein each adaptor assembly is further configured to receive the temperature sensor of one of the heat pump liquid heaters to detect the temperature of the liquid in the corresponding conduit.

14. The heat pump liquid heater system as recited in claim 11, wherein each of the adaptor assemblies comprises an inlet port, an outlet port, and a heat pump port, wherein the liquid flows in the inlet port from the inflow path and out the outlet port to the outflow path.

15. The heat pump liquid heater system as recited in claim 14, wherein the outlet port is connected to a corresponding liquid conduit.

16. The heat pump liquid heater system as recited in claim 14, wherein the liquid conduits are made of a flexible material.

17. The heat pump liquid heater system as recited in claim 15, wherein the heat transfer element extends along substantially the entire length of the corresponding liquid conduit.

18. The heat pump liquid heater system as recited in claim 11, further comprising an air duct system to direct an air flow vented from the heat pump liquid heaters to a desired location.

19. The heat pump liquid heater system as recited in claim 18, wherein the controller is configured to control direction of the air flow to the desired location.

20. A method of heating a liquid in a liquid flow path, comprising:
providing a plurality of heat pump liquid heaters, each heat pump liquid heater comprising a heat transfer element and a temperature sensor;
providing a plurality of liquid conduits arranged in parallel between a liquid inlet and a liquid outlet;
inserting the heat transfer elements and the temperature sensors into the liquid conduits;
detecting with the temperature sensors temperature of a liquid flow through the liquid conduits; and
based on the detected temperature, controlling operation of the heat pump liquid heaters to control transfer of heat from the heat transfer elements to the liquid flow.

21. The method as recited in claim 20, further comprising:
detecting ambient temperature at a location exterior of the heat pump liquid heaters; and
based on the detected ambient temperature, directing an air flow vented from the heat pump liquid heaters to the location.

22. A heat pump liquid heater system, comprising:
a liquid conduit to direct a flow of a liquid between a liquid inlet and a liquid outlet;
a heat pump comprising a condenser tube to transfer heat from a refrigerant in the condenser tube to the liquid in the liquid conduit and a temperature sensor to detect temperature of the liquid, the heat pump further comprising an evaporator coupled to the condenser tube and a fan disposed in an enclosure, the fan configured to direct a flow of air across the evaporator to transfer heat from the air to the refrigerant, the cooled air exiting the enclosure through a vent;
a duct system coupled to the vent to direct the cooled air to a desired location; and
a controller configured to control operation of the heat pump based, at least in part, on the detected temperature of the liquid.

23. The heat pump liquid heater system as recited in claim 22, further comprising a plurality of heat pumps, each heat pump comprising a condenser tube to transfer heat from a refrigerant in the condenser tube to the liquid in the liquid conduit and a temperature sensor to detect temperature of the liquid, wherein the controller is configured to control operation of the plurality of heat pumps based on the detected temperatures.

24. The heat pump liquid heater system as recited in claim 23, wherein the liquid conduit comprises a liquid reservoir, and wherein the condenser tubes extend into the liquid reservoir to transfer heat to the liquid.

25. The heat pump liquid heater system as recited in claim 23, wherein the liquid conduit comprises a plurality of individual liquid conduits, and wherein each of the condenser tubes extends into one of the individual liquid conduits.
